(19) United States
(12) Patent Application Publication
(10) Pub. No.: US 2010/0053310 A1
(43) Pub. Date: Mar. 4, 2010

(54) TRANSFORMING 3D VIDEO CONTENT TO MATCH VIEWER POSITION

(76) Inventors: Brian D. Maxson, Riverside, CA (US); Mike Harvill, Orange, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/551,136

(22) Filed: Aug. 31, 2009

Related U.S. Application Data
(60) Provisional application No. 61/093,344, filed on Aug. 31, 2008.

(51) Int. Cl. H04N 13/04

(52) U.S. Cl. 348/51; 348/E13.001

(57) ABSTRACT

Systems and methods for transforming 3D video content to match a viewer's position to provide a means to make constrained-viewpoint 3D video broadcasts more independent of viewer position. The 3D video display on a television is enhanced by taking 3D video that is coded assuming one particular viewer viewpoint, sensing the viewer's actual position with respect to the display screen, and transforming the video images as appropriate for the actual position. The process provided herein is preferably implemented using information embedded in an MPEG2 3D video stream or similar scheme to shortcut the computationally intense portions of identifying object depth that is necessary for the transformation to be performed.

This application claims priority to provisional application Ser. No. 61/093,344 filed Aug. 31, 2008, which is fully incorporated herein by reference.

### FIELD

The embodiments described herein relate generally to televisions capable of displaying 3D video content and, more particularly, to systems and methods that facilitate the transformation of 3D video content to match viewer position.

### BACKGROUND INFORMATION

Three-dimensional (3D) video display is done by presenting separate images to each of the viewer's eyes. One example of a 3D video display implementation in television, referred to as time-multiplexed 3D display technology using shutter goggles, is shown schematically in FIG. 2. Although reference will be made in this disclosure to time-multiplexed 3D display technology, there are numerous other 3D display implementations and one of skill in the art will readily recognize that the embodiments described herein are equally applicable to the other 3D display implementations.

In time-multiplexed 3D display implementation, different images are sent to the viewer's right and left eyes. As depicted in FIG. 2, images within a video signal 100 are coded as right and left pairs of images 101 and 102, which are decoded separately by the television for display. The images 101 and 102 are staggered in time with the right image 101 being render by the television 10 as picture 105 and the left image 102 being rendered by the television 10 as a picture 106. The television 10 provides a synchronization signal to a pair of LCD shutter goggles worn by the view. The shutter goggles include left and right shutter lenses 107 and 108. The shutter goggles selectively block and pass the light in coordination with the synchronization signal, which is illustrated by grayed out lenses 107 and 108. Thus the viewer's right eye 92 only sees picture 105, the image intended for the right eye 92, and the left eye 90 only sees picture 106, the image intended for the left eye 90. From the information received from the two eyes 90 and 92, and the difference between them, the viewer's brain reconstructs a 3D representation, i.e., image 109, of the object being shown.

In conventional 3D implementations, when the right and left image sequences 101/102, 103, 104 are created for 3D display, the geometry of those sequences assumes a certain fixed location of the viewer with respect to the television screen 18, generally front and center as depicted in FIG. 3A. This is referred to as constrained-viewpoint 3D video. The 3D illusion is maintained, i.e., the viewer's brain reconstructs a correct 3D image 109, so long as this is the viewer's actual position, and the viewer remains basically stationary. However if the viewer watches from some other angle, as depicted in FIG. 3B, or moves about the room while watching the 3D images, the perspective becomes distorted—i.e., objects in the distorted image 209 appear to squeeze and stretch in ways that interfere with the 3D effect. As the desired viewpoint deviates from the front-and-center one, error from several sources—quantization of the video, unrecoverable gaps in perspective, and ambiguity in the video itself—have a larger and larger effect on the desired video frames. The viewer's brain trying to make sense of these changes in proportion, interprets that the user is peering through a long pipe that pivots at the plane of the television screen as the viewer moves his head; the objects being viewed appear at the far end.

It would be desirable to have a system that transforms the given right and left image pair into a pair that will produce the correct view from the user's actual perspective and maintain the correct image perspective whether or not the viewer watches from the coded constrained viewpoint or watches from some other angle.

### SUMMARY

The embodiments provided herein are directed to systems and methods for transforming 3D video content to match a viewer's position. More particularly, the systems and methods described herein provide a means to make constrained-viewpoint 3D video broadcasts more independent of viewer position. This is accomplished by correcting video frames to show the correct perspective from the viewer's actual position. The correction is accomplished using processes that mimic the low levels of human 3D visual perception, so that when the process makes errors, the errors made will be the same errors made by the viewer's eyes—and thus the errors will be invisible to a viewer. As a result, the 3D video display on a television is enhanced by taking 3D video that is coded assuming one particular viewer viewpoint, i.e., a centrally located constrained viewpoint, sensing the viewer's actual position with respect to the display screen, and transforming the video images as appropriate for the actual position.

The process provided herein is preferably implemented using information embedded in an MPEG2 3D video stream or similar scheme to shortcut the computationally intense portions of identifying object depth that is necessary for the transformation to be performed. It is possible to extract some intermediate information from the decoder—essentially reusing work already done by the encoder—to simplify the task of 3D modeling.

Other systems, methods, features and advantages of the example embodiments will be or will become apparent to one with skill in the art upon examination of the following figures and detailed description.

### BRIEF DESCRIPTION OF THE FIGURES

The details of the example embodiments, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a television and control system.

FIG. 2 is a schematic illustrating an example of time-multiplexed 3D display technology using shutter goggles.

FIG. 3A is a schematic illustrating the 3D image viewed by a viewer based a certain viewer location assumed in convention 3D video coding.

FIG. 3B is a schematic illustrating the distorted 3D image viewed by a viewer when in a viewer location that is different than the viewer location assumed in convention 3D video coding.

FIG. 4 is a schematic illustrating the 3D image viewed by a viewer when the 3D video coding is corrected for the viewer's actual position.

FIG. 5 is a schematic of a control system for correcting 3D video coding for viewer location.

FIG. 6 is a perspective view schematic illustrating 3D video viewing system in viewer position sensing.

FIG. 7 is a flow diagram illustrating a process of extracting 3D video coding from a compressed video signal.

FIG. 8 is a flow diagram illustrating a feature depth hypothesis creation and testing process.

FIG. 9 is a flow diagram illustrating a process for evaluating error and transforming to the target coordinate system to transform the video image.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

The systems and methods described herein are directed to systems and methods for transforming 3D video content to match a viewer's position. More particularly, the systems and methods described herein provide a means to make constrained-viewpoint 3D video broadcasts more independent of viewer position. This is accomplished by correcting video frames to show the correct perspective from the viewer's actual position. The correction is accomplished using processes that mimic the low levels of human 3D visual perception, so that when the process makes errors, the errors made will be the same errors made by the viewer's eyes—and thus the errors will be invisible. As a result, the 3D video display on a television is enhanced by taking 3D video that is coded assuming one particular viewer viewpoint, sensing the viewer's actual position with respect to the display screen, and transforming the video images as appropriate for the actual position.

The process provided herein is preferably implemented using information embedded in an MPEG2 3D video stream or similar scheme to shortcut the computationally intense portions of identifying object depth that is necessary for the transformation to be performed. It is possible to extract some intermediate information from the decoder—essentially reusing work already done by the encoder—to simplify the task of 3D modeling.

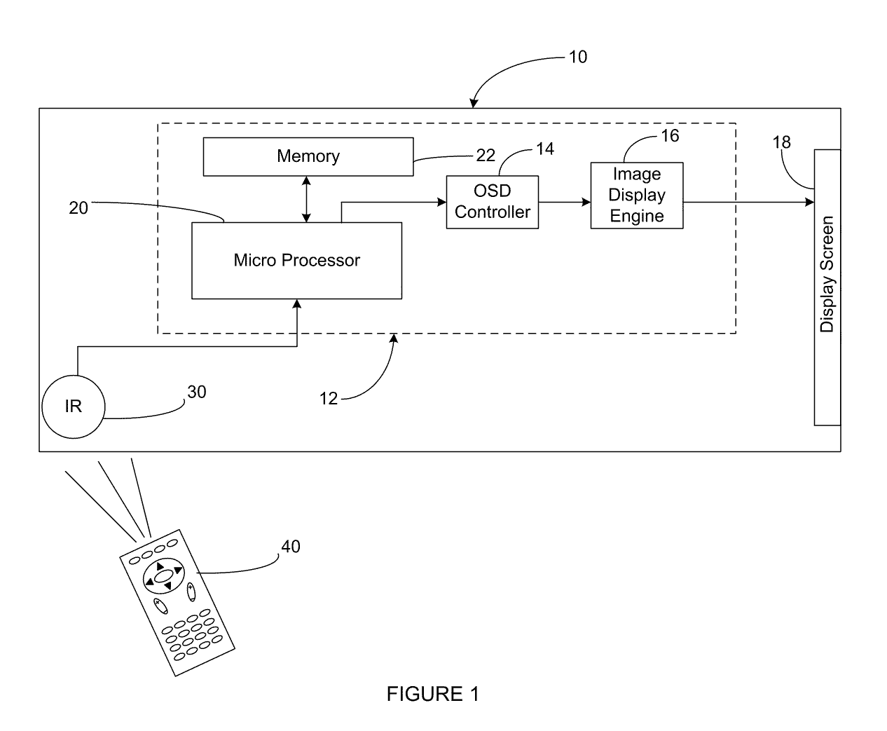

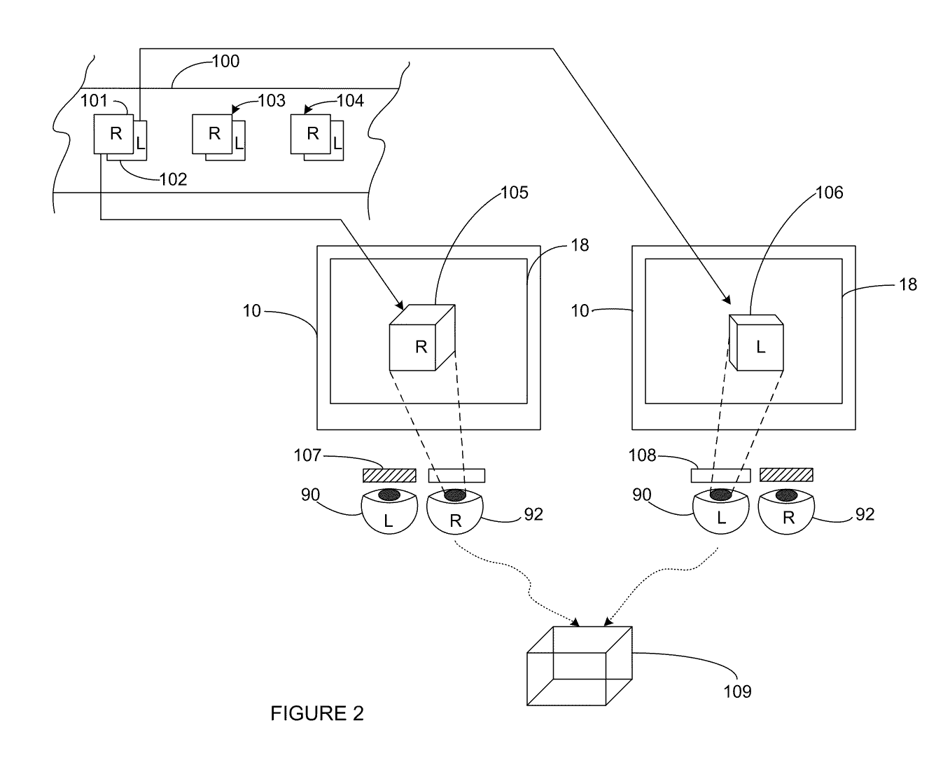

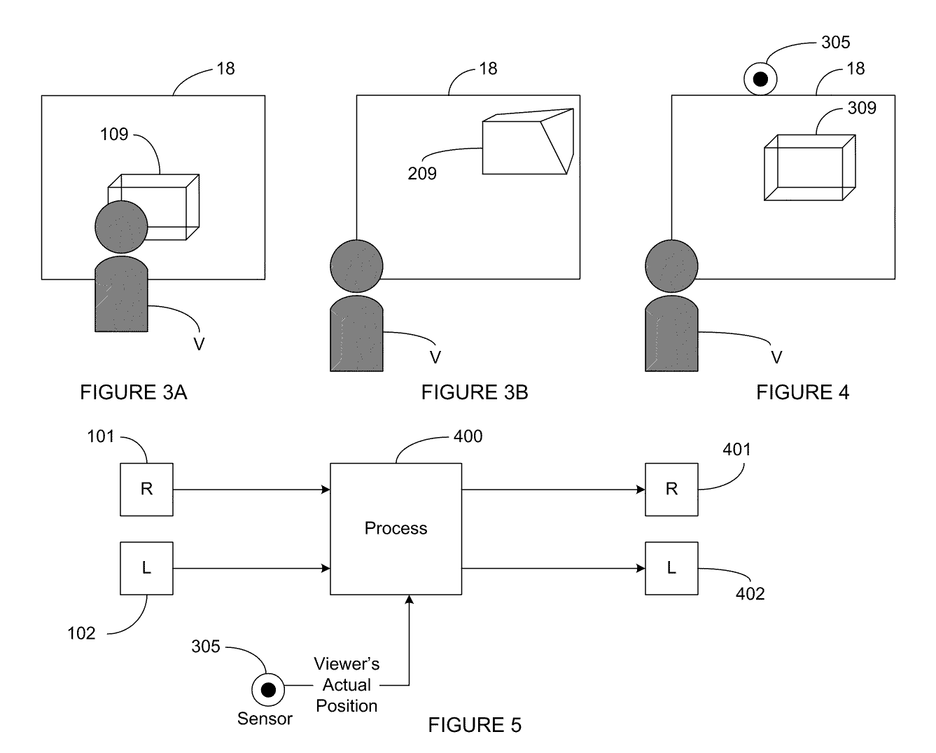

Turning in detail to the figures, FIG. 1 depicts a schematic of an embodiment of a television 10. The television 10 preferably comprises a video display screen 18 and an IR signal receiver or detection system 30 coupled to a control system 12 and adapted to receive, detect and process IR signals received from a remote control unit 40. The control system 12 preferably includes a micro processor 20 and non-volatile memory 22 upon which system software is stored, an on screen display (OSD) controller 14 coupled to the micro processor 20, and an image display engine 16 coupled to the OSD controller 14 and the display screen 18. The system software preferably comprises a set of instructions that are executable on the micro processor 20 to enable the setup, operation and control of the television 10.

An improved 3D display system is shown in FIG. 4 wherein a sensor 305, which is coupled to the microprocessor 20 of the control system 12 (FIG. 1), senses the actual viewer V position which information is used to transform a given right and left image pair into a pair that will produce the correct view or image 309 from the viewer's actual perspective.

As depicted in FIG. 5, the original constrained images 101 and 102 of the right and left image pair are modified by a process 400, described in detail below, into a different right and left pair of images 401 and 402 that result in the correct 3D image 309 from the viewer's actual position as sensed by a sensor 305.

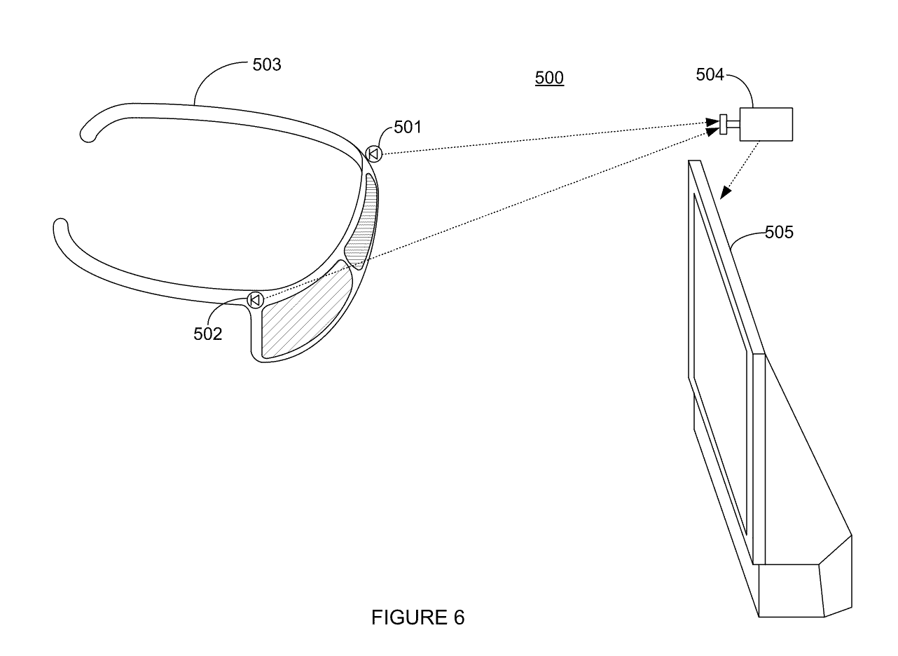

FIG. 6 illustrates an example embodiment of a system 500 for sensing the viewers position. Two IR LED's 501 and 502 are attached to the LCD shutter goggles 503 at two different locations. A camera or other sensing device 504 (preferably integrated into the television 505 itself) senses the position of the LEDs 501 and 502. An example of sensing a viewer's head position has been demonstrated using a PC and cheap consumer equipment (notably IR LED's and a Nindendo Wii remote). See, e.g., http://www.youtube.com/watch?v=Jd3-eiid-Uw&eurl=http://www.cs.cmu.edu/-Johnny/projects/wii/. In this demonstration, a viewer wears a pair of infrared LEDs at his temples. The IR camera and firmware in a stationary “WiiMote” senses those positions and extrapolates the viewer's head position. From that, the software generates a 2d view of a computer-generated 3d scene appropriate to the viewer's position. As the viewer moves his head, objects on the screen move as appropriate to produce an illusion of depth.

Currently, most 3D video will be produced wherein viewpoint-constrained right and left image pairs will be encoded and sent to a television for display, assuming the viewer is sitting front-and-center. However, constrained right and left pairs of images actually contain the depth information of the scene in the parallax between them—more distant objects appear in similar places to the right and left eye, but nearby objects appear with much more horizontal displacement between the two images. This difference, along with other information that can be extracted from a video sequence, can be used to reconstruct depth information for the scene being shown. Once that is done, it becomes possible to create a new right and left image pair that is correct for the viewer's actual position. This enhances the 3D effect beyond what is offered by the fixed front-and-center perspective. A cost-effective process can then be used to generate the 3D model from available information.

The problem of extracting depth information from stereo image pairs is essentially an iterative process of matching features between the two images, developing an error function at each possible match and selecting the match with the lowest error. In a sequence of video frames, the search begins with an initial approximation of depth at each visible pixel; the better the initial approximation, the fewer subsequent iterations are required. Most optimizations for that process fall into two categories:

(1) decreasing the search space to speed up matching, and

(2) dealing with the ambiguities that result.

Two things allow a better initial approximation to be made and speed up matching. First, in video, long sequences of right and left pairs represent, with some exceptions, successive samples of the same scene through time. In general, motion of objects in the scene will be more-or-less continuous. Consequently, the depth information from previous and following frames will have a direct bearing on the depth information in the current frame. Second, if the images of the pair are coded using MPEG2 or a similar scheme that contains both temporal and spatial coding, intermediate values are available to the circuit decoding those frames that:

(1) indicate how different segments of the image move from one frame to the next

(2) indicate where scene changes occur in the video

(3) indicate to some extent the camera focus at different areas.

MPEG2 motion vectors, if validated across several frames, give a fairly reliable estimate of where a particular feature should occur in each of the frames. In other words, a particular feature that was at location X in the previous frame, it moved according to certain coordinates, therefore it should be at location Y in this frame. This gives a good initial approximation for the iterative matching process.

An indication of scene changes can be found in measures of the information content in MPEG2 frames. It can be used to invalidate motion estimations that appear to span scene changes, thus keeping it from confusing the matching process.

Information regarding “focus” is contained in the distribution of discrete co-sine transform (DCT) coefficients. This gives another indication as to the relative depth of objects in the scene—two objects in focus may be at similar depths, where another area out of focus is most likely at a different depth.

The following section addresses the reconstruction/transformation process 400 depicted in FIG. 5. Much 3D information is plainly ambiguous. Much of the depth information collected by human eyes is ambiguous as well. If pressed, it can by resolved by using some extremely complex thought processes. But if those processes are used at all times humans would have to move through their environment very slowly. In other words, a 3D reconstruction process that approximates the decisions made by a human's eyes and their lower visual system and makes the same mistakes that such visual system does, or that doesn't attempt to extract 3D information from the same ambiguous places that a human's brain doesn't attempt to extract 3D information—that process will produce mistakes that are generally invisible to humans. This is quite different from producing a strict map of objects in three dimensions. The process includes:

(1) identifying an adequate model using techniques as close as possible to the methods used by the lowest levels of the human visual system;

(2) transforming that model to the desired viewpoint; and

(3) presenting the results conservatively—not attempting to second-guess the human visual system, and doing this with the knowledge that in a fraction of a second, two more images of information about the same scene will become available.

The best research available suggests that human eyes report very basic feature information and the lowest levels of visual processing run a number of models of the world before simultaneously, continually comparing the predictions of those models against what is seen in successive instants and comparing their accuracy against one another. At any given moment humans have a “best fit” model that they use to make higher-level decisions about the objects they see. But they also have a number of alternate models processing the same visual information, continually checking for a better fit.

Such models incorporate knowledge of how objects in the world work—for example in an instant from now, a particular feature will probably be in a location predicted by where a person sees it right now, transformed by what they know about its motion. This provides an excellent starting approximation of its position in space, that can be further refined by consideration of additional cues, as described below. Structure-from-motion calculations provide that type of information.

The viewer's brain accumulates depth information over time from successive views of the same objects. It builds a rough map or a number of competing maps from this information. Then it tests those maps for fitness using the depth information available in the current right and left pair. At any stage, a lot of information may be unavailable. But a relatively accurate 3D model can be maintained by continually making a number of hypotheses about the actual arrangement of objects, and continually testing the accuracy of the hypotheses against current perceptions, choosing the winning or more accurate hypothesis, and continuing the process.

Both types of 3D extraction—from a right and left image pair or from successive views of the same scene through time—depend on matching features between images. This is generally a costly iterative process. Fortuitously, most image compression standards include ways of coding both spatial and temporal redundancy, both of which represent information useful for short-cutting the work required by the 3D matching problem.

The methods used in the MPEG2 standard are presented as one example of such coding. Such a compressed image can be thought of as instructions for the decoder, telling it how to build an image that approximates the original. Some of those instructions have value in their own right in simplifying the 3D reconstruction task at hand.

In most frames, an MPEG2 encoder segments the frame into smaller parts and for each segment, identifies the region with the closest visual match in the prior (and sometimes the subsequent) frame. This is typically done with an iterative search. Then the encoder calculates the x/y distance between the segments and encodes the difference as a “motion vector.” This leaves much less information that must be encoded spatially, allowing transmission of the frames using fewer bits than would otherwise be required.

Although MPEG2 refers to this temporal information as a “motion vector,” the standard carefully avoids promising that this vector represents actual motion of objects in the scene. In practice, however, the correlation with actual motion is very high and is steadily improving. (See, e.g., Vetro et al., “True Motion Vectors for Robust Video Transmission,” SPIE VPIC, 1999 (to the extent that MPEG2 motion vectors matched actual motion, the resulting compressed video might see a 10% or more increase in video quality at a particular data rate.)) It can be further validated by checking for “chains” of corresponding motion vectors in successive frames; if such a chain is established it probably represents actual motion of features in the image. Consequently this provides a very good starting approximation for the image matching problems in the 3D extraction stages.

MPEG2 further codes pixel information in the image using methods that eliminate spatial redundancy within a frame. As with temporal coding, it is also possible to think of the resulting spatial information as instructions for the decoder. But again, when those instructions are examined in their own right they can make a useful contribution to the problem at hand:

(1) the overall information content represents the difference between current and previous frames. This allows for making some good approximations about when scene changes occur in the video, and to give less credence to information extracted from successive frames in that case;

(2) focus information: This can be a useful cue for assigning portions of the image to the same depth. It can't tell foreground from background, but if something whose depth is known is in focus in one frame and the next frame, then its depth probably hasn't changed much in between.

Therefore the processes described herein can be summarized as follows:

1. Cues from the video compressor are used to provide initial approximations for temporal depth extraction;

2. A rough depth map of features is created with 3D motion vectors from a combination of temporal changes and right and left disparity through time;

3. Using those features which are unambiguous in the current frame, the horizontal disparity is used to choose the best values from the rough temporal depth information;

4. The resulting 3D information is transformed to the coordinate system at the desired perspective, and the resulting right and left image pair are generated;

5. The gaps in those images are repaired; and

6. Model error, gap error and deviation from the user's perspective and the given perspective are evaluated to limit the amount of perspective adjustment applied, keeping the derived right and left images realistic.

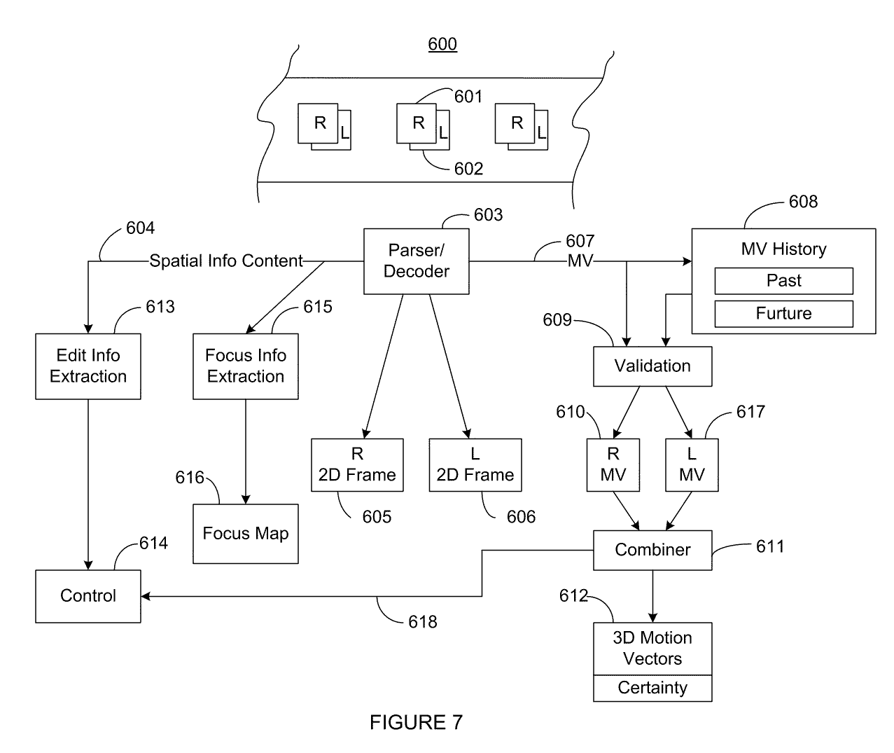

This process is described in greater detail below with regard to FIGS. 7, 8 and 9. FIG. 7 illustrates the first stage 600 of the 3D extraction process which collects information from a compressed constrained-viewpoint 3D video bitstream for use in later stages of the process. As depicted, the input bitstream consists of a sequence of right and left image pairs 601 and 602 for each frame of video. These are assumed to be compressed using MPEG2 or some other method that reduces temporal and spatial redundancy. These frames are fed to an MPEG2 parser/decoder 603, either serially or to a pair of parallel decoders. In a display that shows constrained-viewpoint video without the enhancements described herein, the function of this stage is simply to produce the right and left frames, 605 and 606. Components of 600 extract additional information from the sequence of frames and make this information available to successive computation stages. The components which extract additional information include but are not limited to the following:

The Edit Info Extractor 613 operates on measures of information content in the encoded video stream that identifies scene changes and transitions—points at which temporal redundancy becomes suspect. This information is sent to a control component 614. The function of the control component 614 spans each stage of the process as it controls many of the components illustrated in FIGS. 7, 8 and 9.)

The Focus Info Extractor 615 examines the distribution of Discrete Cosine Transform (DCT) coefficients (in the case of MPEG-2) to build a focus map 616 that groups areas of the image in which the degree of focus is similar.

A Motion Vector Validator 609 checks motion vectors (MVs) 607 in the coded video stream based on their current values and stored values to derive more trustworthy measurements of actual object motion in the right and left scenes 610 and 617. The MVs indicate the rate and direction an object is moving. The validator 609 uses the MV data to project where the object would be and then compares that with where the object actually is to validate the trustworthiness of the MVs.

The MV history 608 is a memory of motion vector information from a sequence of frames. Processing of frames at this stage precedes actual display of the 3D frames to the viewer by one or more frame times—thus the MV history 608 consists of information from past frames and (from the perspective of the current frame) future frames. From this information it is possible to derive a measure of certainty that each motion vector represents actual motion in the scene, and to correct obvious deviations.

The two processing components, the Edit Info Extractor 613 and the Focus Info Extractor 615, process the spatial measures information. The Edit Info Extractor 613 identifies scene changes and transitions—points at which temporal redundancy becomes suspect. This information is sent to a control component 614. The function of the control component 614 spans each stage of the process as it controls many of the components illustrated in FIGS. 7, 8 and 9.

The Focus Info Extractor 615 examines the distribution of DCT coefficients to build a focus map 616 that groups areas of the image in which the degree of focus is similar.

Motion vectors (MVs) 607 are validated by validator 609 based on their current values and stored values to derive more trustworthy measurements of actual object motion in the right and left scenes 610 and 617. The MVs indicate the rate and direction an object is moving. The validator 609 uses the MV data to project where the object would be and then compares that with where the object actually is to validate the trustworthiness of the MVs. The MV history 608 is a memory of motion vector information from a sequence of frames. Processing of frames at this stage precedes actual display of the 3D frames to the viewer by one or more frame times—thus the MV history 608 consists of information from past frames and (from the perspective of the current frame) future frames. From this information it is possible to derive a measure of certainty that each motion vector represents actual motion in the scene, and to correct obvious deviations.

Motion vectors from the right and left frames 610 and 617 are combined by combiner 611 to form a table of 3D motion vectors 612. This table incorporates certainty measures based on certainty of the “2D” motion vectors handled before and after this frame, and unresolvable conflicts in producing the 3d motion vectors (as would occur at a scene change.)

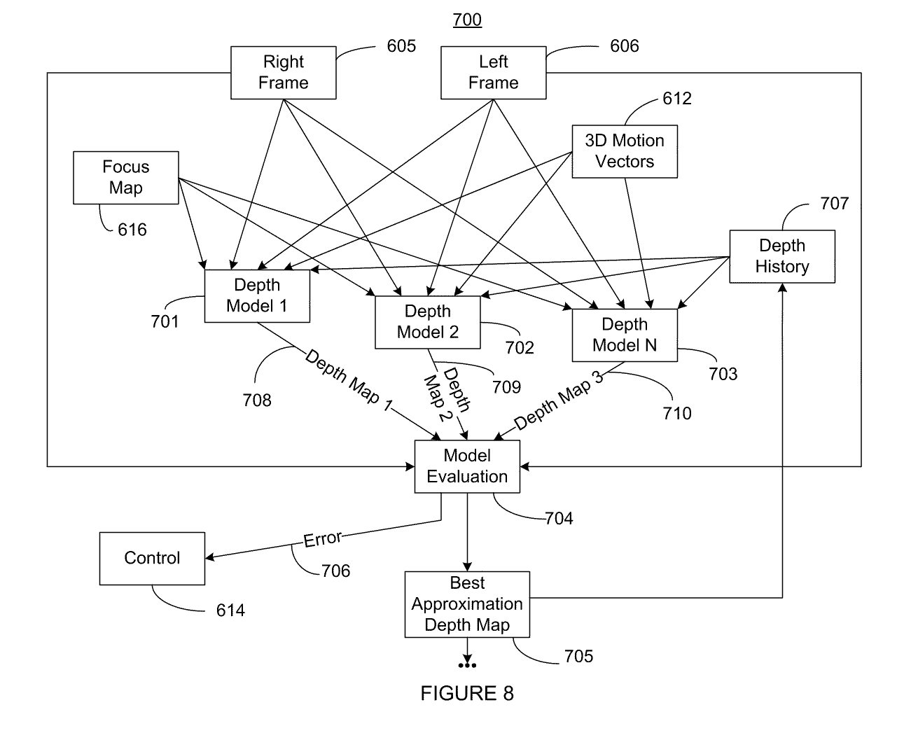

FIG. 8 illustrates the middle stage 700 of the 3D extraction process provided herein. The purpose of the middle stage 700 is to derive the depth map that best fits the information in the current frame. Information 616, 605, 606 and 612 extracted from the constrained-viewpoint stream in FIG. 7 becomes the inputs for a number N of different depth model calculators, Depth Model_1 701, Depth Model_2 702, . . . and Depth Model_N 703. Each Depth Model uses a particular set of the above extracted information, plus its own unique algorithm, to derive an estimation of depth at each point and where appropriate, to also derive a measure of certainty in its own answer. This is further described below.

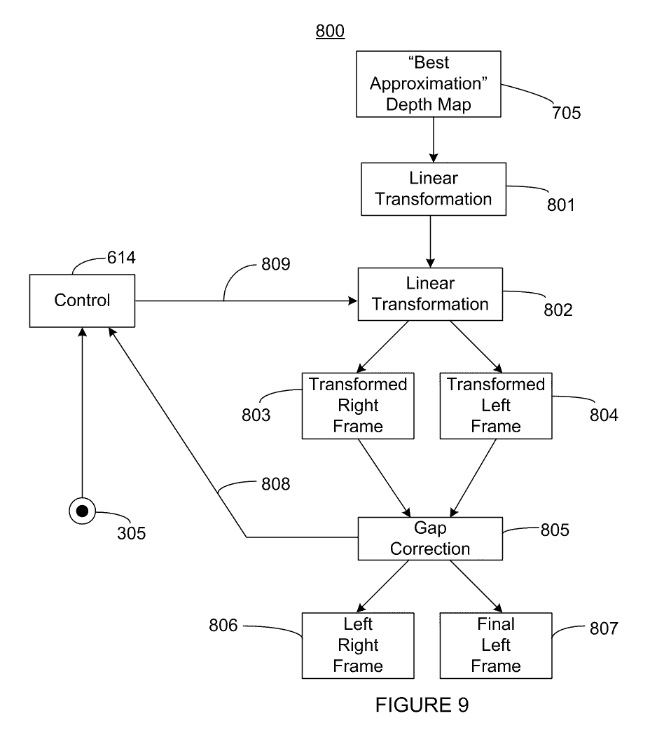

Once the Depth Models have derived their own estimates of depth at each point, their results are fed to a Model Evaluator. This evaluator chooses the depth map that has the greatest possibility of being correct, as described below, and uses that best map for its output to the rendering stage in 800 (FIG. 9.)

The depth model calculators 701, 702, . . . and 703 each attend to a certain subset of the information provided by stage 600. Each depth model calculator then applies an algorithm, unique to itself, to that subset of the inputs. Finally, each one produces a corresponding depth map, (Depth Map_1 708, Depth Map_2 709, . . . and Depth Map_N 710) representing each model's interpretation of the inputs. This depth map is a hypothesis of the position of objects visible in the right and left frames, 605 and 606.

Along with that depth map, some depth model calculators may also produce a measure of certainty in its own depth model or hypothesis—this is analogous to a tolerance range in physical measurements—e.g. “This object lies 16 feet in front of the camera, plus or minus four feet.”

In one example embodiment, the depth model calculators and the model evaluator would be implemented as one or more neural networks. In that case, the depth model calculator operates as follows:

1. Compare successive motion vectors from the previous two and next two “left” frames, attempting to track the motion of a particular visible feature across the 2d area being represented, over 5 frames.

2. Repeat step 1 for right frames.

3. Using correlation techniques described above, extract parallax information from the right and left pair by locating the same feature in pairs of frames.

4. Use the parallax information to add a third dimension to its motion vectors.

5. Apply the 3d motion information to the 3d positions of the depth map chosen by the Model Evaluator in the previous frame to derive where in 3 dimensions the depth model thinks each feature must be in the current frame.

6. Derive a certainty factor by evaluating how closely each of the vectors matched previous estimates—if there are many changes then the certainty of its estimate is lower. If objects in the frame occurred in the expected places in the evaluated frames, then the certainty is relatively high.

In another example embodiment, the depth model calculator relies entirely on the results provided by the Focus Info Extractor 615 and the best estimate of features in the prior frame. It simply concludes that those parts of a picture that were in focus in the last frame, probably remain in focus in this frame, or if they are slowly changing in focus across successive frames, then all objects evaluated to be at the same depth should be changing in focus at about the same rate. This focus-oriented depth model calculator can be fairly certain about features in the frame remaining at the same focus in the following frame. However, features which are out of focus in the current frame cannot provide very much information about their depth in the following frame, so this depth model calculator will report that it is much less certain about those parts of its depth model.

The Model Evaluator 704 compares hypotheses against reality, to choose the one that matches reality the best. In other words, the Model Evaluator compares the competing depth maps 708, 709 and 710 against features that are discernible in the current right and left pair and chooses the depth model that would best explain what it sees in the current right/left frames (605, 606.) The model evaluator is saying, “if our viewpoint were front-and-center, as required by the constrained viewpoint of 605/606, which of these depth models would best agree with what we see in those frames (605, 606) at this moment?”

The Model Evaluator can consider the certainty information, where applicable, provided by depth model calculators. For example if two models give substantially the same answer but one is more certain of its answer than the other, the Model Evaluator may be biased towards the more confident one. On the other hand, the certainty of a depth model may be developed in isolation from the others, and one that deviates very much from the depth models of other calculators (particularly if those calculators have proven to be correct in prior frames) then even if that deviating model's certainty is high, the Model Evaluator may give it less weight.

As shown implicitly in the example above, the Model Evaluator retains a history of the performance of different models and can use algorithms of its own to enhance its choices. The Model Evaluator is also privy to some global information such as the output of the Edit Info Extractor 613 via the control component 614. As a simple example, if a particular model was correct on the prior six frames, then barring a scene change, it is more likely than the other model calculators to be correct on the current frame.

From the competing depth maps it chooses the “best approximation” depth map 705. It also derives an error value 706 which measures how well the best approximation depth map 705 fits the current frame's data.

From the standpoint of the evaluator 704, “what we see right now” is the supreme authority, the criterion against which to judge the depth models, 701, 702, . . . and 703. It is an incomplete criterion, however. Some features in the disparity between right and left frames 605 and 606 will be unambiguous, and those are valid for evaluating the competing models. Other features may be ambiguous and will not be used for evaluation. The Model Evaluator 704 measures its own certainty when doing its evaluation and that certainty becomes part of the error parameters 706 that it passes to the control block 614. The winning depth model or best approximation depth map 705 is added to the depth history 707, a memory component to be incorporated by the depth model calculators when processing the next frame.

FIG. 9 shows the final stage 800 of the process. The output of the final stage 800 is the right and left frames 805 and 806 that give the correct perspective to the viewer, given his actual position. In FIG. 9, the best approximation depth map 705 is transformed into a 3D coordinate space 801 and from there, transformed in a linear transformation 802 into right and left frames 803 and 804 appropriate to the viewer's position as sensed by 305. Given that the perspective of the 3D objects in the transformed right and left frames 803 and 804 is not the same as the constrained viewpoint, there may be portions of the objects represented which are visible from the new perspective but which were not visible from the constrained viewpoint. This results in gaps in the images—slices at the back edges of objects that are now visible. To some extent these can be corrected by extrapolating from surface information from nearby visible features on the objects. Those missing pieces may also be available from other frames of the video prior to or following the current one. However it is obtained, the Gap Corrector 805 restores missing pieces of the image, to the extent of its abilities. A gap is simply an area on the surface of some 3d object whose motion is more-or-less known, but which has not been seen in frames that are within the range of the present system's memory.

For example, if a gap is sufficiently narrow, repeating texture or pattern on an object contiguous with the gap in space may be sufficient to keep the ‘synthesized’ appearance of the gap sufficiently natural that the viewer's eye isn't drawn to it. If this pattern/texture repetition is the only tool available to the gap corrector, however, this constrains how far from front-and-center the generated viewpoint can be, without causing gaps that are too large for the system to cover convincingly. For example if the viewer is 10 degrees off center, the gaps may be narrow enough to easily synthesize a convincing surface appearance to cover them. If the viewer moves 40 degrees off center, the gaps will be wider and this sort of simple extrapolated gap concealing algorithm may not be able to keep the gap invisible. In such a case, it may be preferable to have the gap corrector fail gracefully, showing gaps when necessary rather than synthesizing an unconvincing surface.

An example of more sophisticated gap-closing algorithms is provided in Brand et al., “Flexible Flow for 3D Nonrigid Tracking and Shape Recovery,” (2001) at http://www wisdom.weizmann.ac.il/˜vision/courses/2003_{—}2/4B_{—}06.pdf, which is incorporated herein by reference. In Brand, the writers developed a mechanism for modeling a 3d object from a series of 2d frames by creating a probabilistic model whose predictions are tested and re-tested against additional 2d views. Once the 3d model is created, a synthesized surface can be wrapped over the model to make more convincing concealment of larger and larger gaps

The control block 614 receives information about edits 613. At a scene change, no motion vector history 608 is available. The best the process can hope to do is to match features in the first frame it sees in the new scene, use this as a starting point and then refine that using 3D motion vectors and other information as it becomes available. Under these circumstances it may be best to present a flat or nearly flat image to the viewer, until more information becomes available. Fortunately, this is the same thing that the viewer's visual processes are doing, and the depth errors are not likely to be noticed.

The control block 614 also evaluates error from several stages in the process:

(1) gap errors from gap corrector 804;

(2) fundamental errors 706 that the best of the competing models couldn't resolve;

(3) errors 618 from incompatibilities in the 2D motion vectors in the right and left images, that couldn't be combined into realistic 3D motion vectors.

From this error information, the control block 614 can also determine when it is trying to reconstruct frames beyond its ability to produce realistic transformed video. This is referred to as the realistic threshold. As was noted before, errors from each of these sources become more acute as the disparity between the constrained viewpoint and desired one increases. Therefore, the control block will clamp the coordinates of the viewpoint adjustment at the realistic threshold—sacrificing correct perspective in order to produce 3D video that doesn't look unrealistic.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A process for transforming 3D video content to match viewer position, comprising the steps of
sensing the actual viewer's position, and
transforming a first sequence of right and left image pairs into a second sequence of right and left image pairs as function of viewer's sensed position, wherein the second right and left image pair produces a image that appears correct from a viewer's actual perspective.

2. The process of claim 1 wherein the step of transforming comprises the steps of
receiving a sequence of right and left image pairs for each frame of video bitstream, the sequence of right and left image pairs being compressed by a method that reduces temporal and spatial redundancy, and
parsing from the sequence of right and left image pairs 2D dimensional images for right and left frames, and spatial information content and motion vectors.

3. The process of claim 2 further comprising the steps of identifying points at which temporal redundancy become suspect within parsed spatial information.

4. The process of claim 3 further comprising the steps of building a focus map as a function of DCT coefficient distribution within parsed spatial information, wherein the focus map groups areas of the image in which the degree of focus is similar.

5. The process of claim 4 further comprising the step of validating motion vectors based on current values and stored values.

6. The process of claim 5 further comprising the step of combining the motion vectors from the right and left frames to form a table of 3D motion vectors.

7. The process of claim 6 further comprising the step of deriving a depth map for the current frame.

8. The process of claim 7 wherein the step of deriving a depth map comprises the step of
generating three or more depth maps as a function of the points at which temporal redundancy becomes suspect, the focus map, the 3D motion vectors, the stored historic depth data and the 2D dimensional images for right and left frames,
comparing the three or more depth maps against discernible features from the 2D dimensional images for right and left frames,
selecting a depth map from the three or more depth maps, and
adding selected depth map to depth history.

9. The process of claim 8 further comprising the steps of outputting the right and left frames as a function of the selected depth to provide a correct perspective to the viewer from viewer's actual position.

10. The process of claim 9 wherein the step of outputting right and left frames comprising the steps of
transforming the selected depth map into 3D coordinate space, and
generating right and left frames from transformed depth map data wherein the right and left frames appear with appropriate perspective from the viewer's sensed position.

11. The process of claim 10 further comprising the steps of
restoring missing portions of the image, and
displaying the image on a display screen.
